(19) United States
(12) Patent Application Publication
(10) Pub. No.: US 2013/0167439 A1
(43) Pub. Date: Jul. 4, 2013

(54) GARDEN TILE WITH WATER CHANNELS

(71) Applicant: Sean Herrberg, Xenia, OH (US)

(72) Inventor: Sean Herrberg, Xenia, OH (US)

(21) Appl. No.: 13/340,821

(22) Filed: Dec. 30, 2011

(51) Int. Cl. A01G 1/00; F16L 3/00

(52) U.S. Cl. 47/58.1 R; 137/356

(57) ABSTRACT

A garden tile comprises a body including a top and a first edge. The body is constructed of a rigid material allowing a person to walk upon the body without substantially deforming the body and without substantially deforming the water channel. Further, the top of the body includes a water channel that is sloped toward the first edge of the body. When placed in a garden, the water channel directs water from the top of the tile to any plant roots near the first edge of the garden tile.

### CROSS-REFERENCE TO RELATED APPLICATIONS

This application claims priority to U.S. provisional patent application No. 61/640,379 filed Dec. 31, 2010 entitled GARDEN TILE SYSTEMS AND METHODS, the disclosure of which is incorporated herein by reference.

### BACKGROUND

The present invention relates to garden tiles, and specifically to garden tiles with integrated channels to direct water toward roots of plants within a garden.

Gardening is not only an extremely popular and beloved activity, but gardening can also make society more environmentally friendly. By producing food through gardening, greenhouse gasses associated with mechanized food production and transport is reduced. In addition to environmental benefits, gardening also provides health benefits to people who consume freshly grown fruits and vegetables.

### BRIEF SUMMARY

According to aspects of the present invention, a garden tile comprises a body including a top and a first edge. The body includes water channels that are open to the top of the body and extend from the top of the body to slope toward the first edge of the body. Further, the body is constructed of a rigid material allowing a person to walk upon the garden tile without substantially deforming the body and without substantially deforming the water channel.

According to further aspects of the present invention, a method of gardening comprises placing, on the ground, a first garden tile including water channels sloped toward a first edge of the first garden tile. Further, the method comprises placing, on the ground generally parallel to the first garden tile, a second garden tile including water channels sloped toward a first edge of the second garden tile, such that the first edge of the first garden tile is facing the first edge of the second garden tile, and such that the first garden tile is spaced apart from the second garden tile to form a planting row. Then, the method includes planting plants in the planting row.

### BRIEF DESCRIPTION OF THE SEVERAL VIEWS OF THE DRAWINGS

FIG. 1 is a perspective view of a garden tile with integrated water channels that slope from a center of the tile to both edges of the garden tile, according to aspects of the present invention;

FIG. 2 is a cross-sectional view of the garden tile of FIG. 1 without any bottom channels, according to aspects of the present invention;

FIG. 3 is a cross-sectional view of the garden tile of FIG. 1 with two bottom channels, according to aspects of the present invention;

FIG. 4 is a perspective view of a garden tile with integrated water channels that slope from one edge of the garden time to an opposite edge of the garden tile, according to aspects of the present invention;

FIG. 5 is a cross-sectional view of the garden tile of FIG. 4 without any bottom channels, according to aspects of the present invention;

FIG. 6 is a cross-sectional view of the garden tile of FIG. 4 with two bottom channels, according to aspects of the present invention;

FIG. 7 is a perspective view of an exemplary garden using the garden tiles of FIGS. 1-6, according to aspects of the present invention;

FIG. 8 is a cross-sectional view of the garden of FIG. 7, according to aspects of the present invention;

FIG. 9 is a perspective view of another exemplary garden using the tiles of FIGS. 1-6, according to aspects of the present invention;

FIG. 10 is a perspective view of two garden tiles with hook portions of a hook-and-loop coupler, according to aspects of the present invention;

FIG. 11 is a perspective view of the garden tiles of FIG. 10 coupled together with a loop portion of the hook-and-loop coupler, according to aspects of the present invention; and

FIG. 12 is a perspective view of a garden tile with distance markings, according to aspects of the present invention.

### DETAILED DESCRIPTION

Various aspects of the present invention provide a gardening tile to assist a gardener in the process of gardening. By way of illustration, the gardening tile includes integrated water channels that slope down toward one or more edges of the gardening tile. When placed in a garden with the roots of plants close to the edges of the garden tile, the water channels direct water from any source (e.g., rain, irrigation system, watering, etc.) to the roots of the plants. Thus, water that would normally fall on an area of the garden without any plants falls instead on the garden tile. The garden tile collects the water in the water channels and directs the water to the roots of the plants in the garden. Therefore, as an example, less water is wasted when watering the garden.

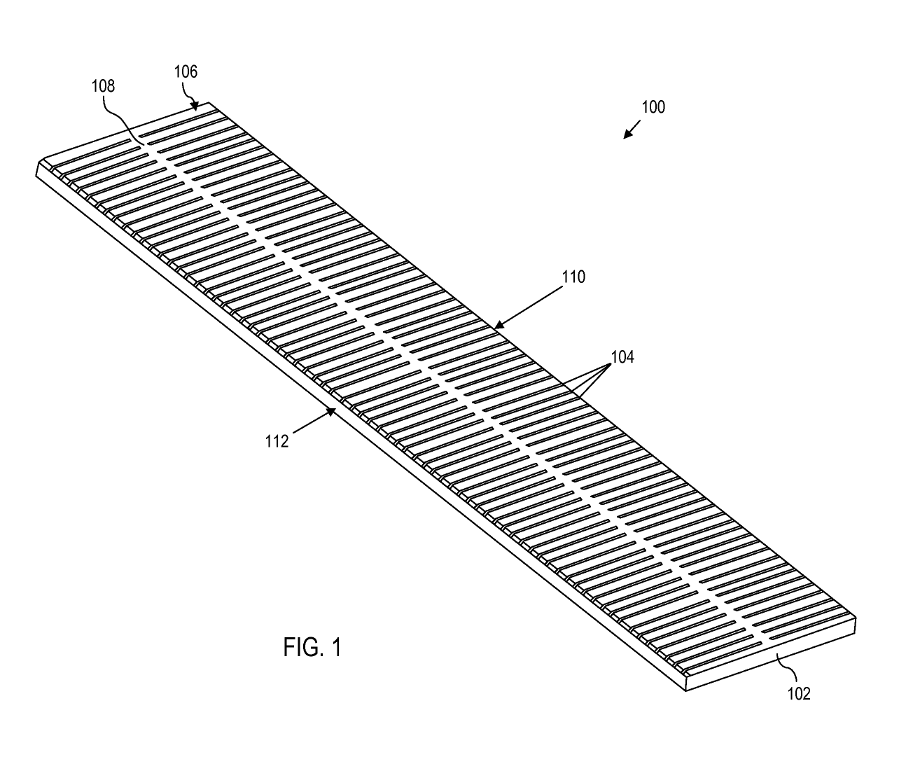

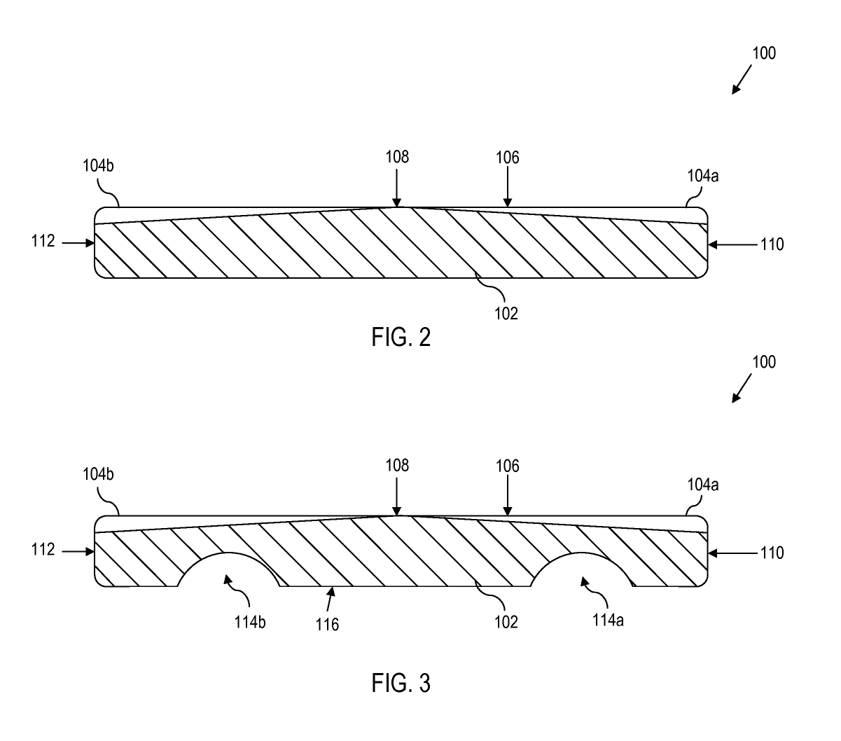

Referring now to the figures (which are not necessarily drawn to scale), and in particular to FIG. 1, a garden tile 100 is shown. The garden tile 100 has an elongated body 102 with water channels 104 integrated into the top 106 of the garden tile 100. In the exemplary embodiment shown in FIG. 1, a first set of water channels 104 start generally near a first side of a center line 108 of the body 102 (seen just to the right of the center line 108 in FIG. 1) and deepen towards a first elongated edge 110 of the garden tile 100. A second set of water channels 104 start generally near a second side of the center line 108 of the body 102 (seen just to the left of the center line 108 in FIG. 1) and deepen towards a second elongated edge 112 of the garden tile 100. The water channels 104 are shown in more detail below in references to FIGS. 2 and 3.

The body 102 of the garden tile 100 is constructed of rot-resistant materials such as, but not limited to, treated wood, decking materials (e.g., ChoiceDek™, Trex®, etc.), plastics, elastomers, composites, etc. Trex® is a registered trademark of Trex Company, Inc. incorporated in Delaware and has a principal place of business at 160 Exeter Drive in Winchester, Va. 22603. Further, the body 102 is rigid such that the body 102 can support the weight of a person walking on the garden tile 100. In illustrative implementations, the body 102 of the garden tile 100 is resilient and can support the weight of a person or other load, e.g., weight in excess of 200-250 pounds, without deforming or otherwise damaging the garden tile 100 or the channels 104 integrated into the body 102 of the garden tile 100. In alternative illustrative examples, the body 102 is elastic such that the garden tile 100 may exhibit a slight deformation due to a load, e.g., due to the weight of a person walking across the body 102, but will return to an initial form following such deformation.

The edges 110, 112 of the garden tile 100, corners on the garden tile 100, or a combination thereof may be shaped to reduce the possibility of chipping, other damage, or both. As such, the edges 110, 112, corners or both may be chamfered, rounded, etc.

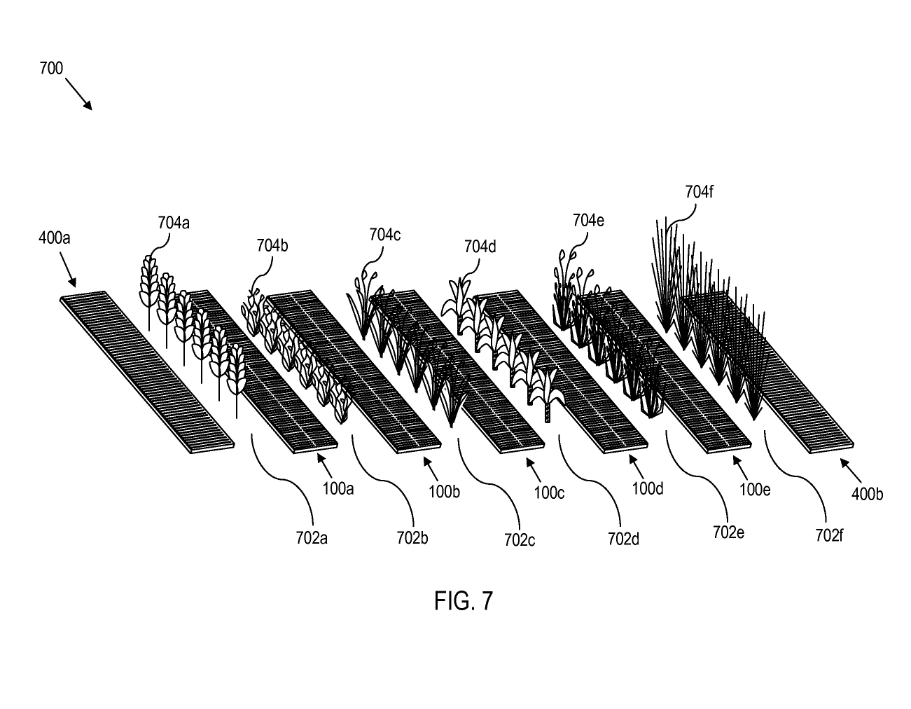

In the exemplary embodiment shown in FIG. 1, the garden tile 100 is generally rectangular in shape; however, other the body shapes may be implemented. Moreover, the body shape can be used to determine the shape of rows for planting plants in a garden, as is described in greater detail below in reference to FIG. 7.

The dimensions of the garden tile 100 may be any dimensions. For example, in the exemplary rectangular embodiment of FIG. 1, the width of the body 102 of the garden tile 100 is thirty-and-one-half centimeters (“cm”) (approx. twelve inches) between the first edge 110 and the second edge 112; the length of the body 102 is 244 cm (approx. ninety-six inches); and the depth of the body 102 is 3.81 cm (approx. one-and-a-half inches). However, other dimensions may be used. For example, the width may be sixty-one cm (approx. twenty-four inches), and the length may be 183 cm (approx. seventy-two inches).

Moreover, the water channels 104 in the body 102 may be spaced apart at any desired distance. In the exemplary embodiment of FIG. 1, the water channels 104 are spaced apart by 2.54 cm (approx. one inch). However, any distance may be used depending on the desired water flow characteristics desired for the garden tile 100, because the length of the garden tile 100, the distance between the water channels 104, and the width of the water channels 104 define the maximum number of water channels 104 that can fit on the body 102 of the garden tile 100.

In illustrative implementations, the width of a water channel 104 may range from 0.159-2.54 cm (approx. one-sixteenth of an inch to one inch). For example, in the exemplary embodiment of FIG. 1, the width of the water channels 104 is 0.3175 cm (approx. one-eighth of an inch). Furthermore, the width of the water channels 104 does not have to be uniform across all of the water channels 104, nor does the width of each individual water channel 104 need to be constant across that water channel 104.

In illustrative implementations, except for the water channels 104, the top 106 of the garden tile 100 is generally flat as opposed to being sloped. Thus, a person can walk on the garden tile 100 without slipping. Moreover, although the channels 104 can be any desired width, in the illustrative implementation, the channel width is insufficient for a person walking across the garden tile 100 to slip down a slope of the channel that is used to direct water toward plant roots. For instance, as noted above, the width of a water channel 104 may typically range from 0.159-2.54 cm (approx. one-sixteenth of an inch to one inch).

Referring now to FIG. 2, an exemplary cross section at a pair of water channels 104a, 104b (collectively 104) of the exemplary garden tile 100 of FIG. 1 is shown. As mentioned above, the top 106 of the body 102 includes water channels 104a, 104b, which extend in opposite directions from each other generally orthogonal (i.e., at a right angle, but not necessarily in the same plane) to the elongated edges 110, 112 and starting generally at the center 108 of the top 106 of the body 102.

The exemplary water channels 104 of FIG. 2 increase in depth linearly from the general center 108 of the top 106 of the body 102 toward the elongated edges 110, 112 of the body such that the depth of the water channels 104 at the edges 110, 112 is 0.525 cm (approx. 3/16 inch). Thus, the slope of the water channel 104 is approximately 1-4 degrees from the top 106 of the body 102 of the garden tile.

The water channels 104 do not necessarily need to be linearly sloped. To the contrary, any manner sloping may be used (e.g., 1/x, x², etc.). However, the sloping of the depth of the water channels 104 should be monotonic (i.e., x₁≦x₂≦xₙ) to prevent water from pooling in the water channels 104, but monotonic sloping is not necessary. Further, each water channel 104 in the garden tile 100 does not need to be uniform with other water channels 104 within the garden tile 100.

Referring now to FIG. 3, an exemplary cross section at a pair of water channels 104a, 104b (collectively 104) of another exemplary garden tile 100 is shown. the garden tile of FIG. 3 differs from the garden tile of FIG. 1 in that the garden tile 100 depicted in FIG. 3 includes two bottom channels 114a, 114b (collectively 114) in the bottom 116 of the body 104 of the garden tile 100. The bottom channels 114 are generally orthogonal to the water channels 104. The bottom channels 114 accommodate irrigation piping, accommodate irrigation tubing, reduce the amount of material used to create the garden tile 100, improve longitudinal characteristics, etc.

The exemplary garden tile 100 of FIG. 3 includes two bottom channels 114a, 114b; however, a different number of bottom channels 114 may be used (e.g., one channel, three channels, four channels, zero channels (as depicted in FIG. 2), etc.). Further, the bottom channels 114 may extend throughout the entire length of the garden tile 100 or may extend for only a portion of the garden tile 100. Moreover, as mentioned above, the bottom channels 114 are orthogonal to the water channels 104; however, other orientations of the bottom channels 114 are available. For example, the bottom channels may be parallel to the water channels 104, or the bottom channels 114 may not be linear at all and include some bends or curves.

As can be seen in the exemplary garden tiles of FIGS. 2-3, the water channels 114 do not cut entirely through the body 102 from top 106 to bottom 116. Therefore, when placed in a garden, no sunlight reaches the portion of the garden covered by the garden tile 100. Without sunlight, weeds will not grow beneath the garden tile 100. Thus, the garden tile 100 helps reduce time spent weeding by a gardener and herbicide usage. Also, less water will evaporate from the garden because less of the soil's surface area is exposed to the atmosphere.

The exemplary garden tiles discussed in reference to FIGS. 1-3 direct water that falls upon the garden tile 100 through the water channels 104 to both edges 110, 112 of the garden tile 100. Thus, the garden tiles 100 of FIGS. 1-3 will water plants along both edges of the garden tile 100 and are suitable for placement within the middle of a garden while still allowing a stable, flat surface for a person to walk upon.

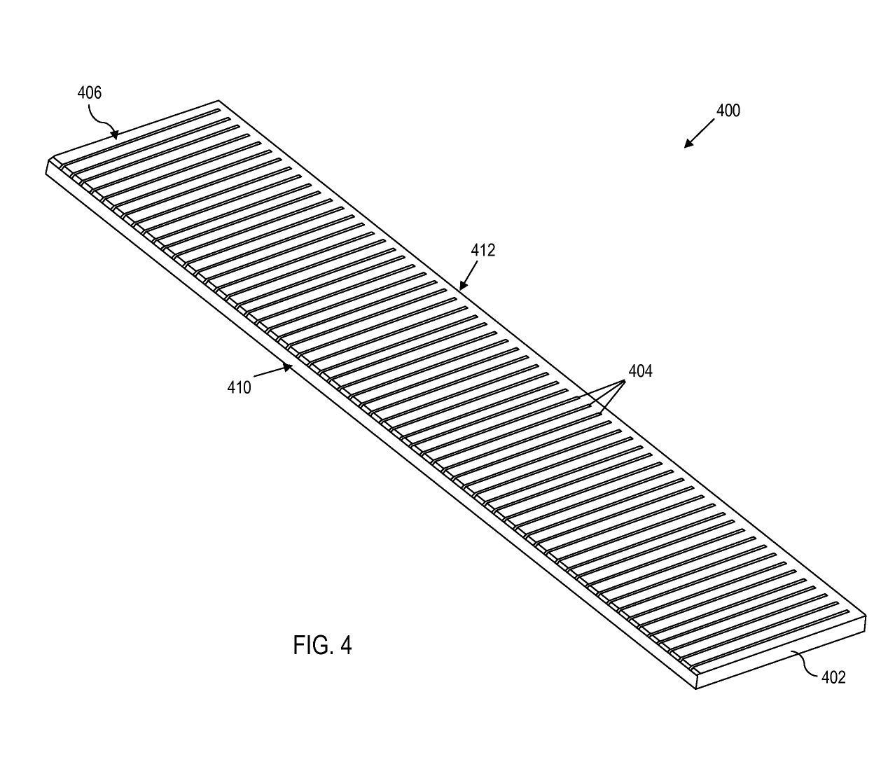

Referring now to FIG. 4, an exemplary garden tile 400 is shown. This exemplary garden tile 400 is similar to the garden tile 100 of FIG. 1, except the body 402 of the garden tile 400 of FIG. 4 includes water channels 404 integrated into the top 406, and those water channels 404 slope to a first elongated edge 410 generally from a second elongated edge 412 as opposed to sloping from the center like the garden tile 100 of FIG. 1.

Similar to the garden tile 100 of FIG. 1, the body 402 of the garden tile 400 is constructed of rot-resistant materials such as, but not limited to, treated wood, decking materials (e.g., ChoiceDek™, Trex®, etc.), plastics, elastomers, composites, etc. Further, the body 402 is rigid such that the body 402 can support the weight of a person walking on the garden tile 400. In illustrative implementations, the body 402 of the garden tile 400 is resilient and can support the weight of a person or other load, e.g., weight in excess of 200-250 pounds, without deforming or otherwise damaging the garden tile 400 or the channels 404 integrated into the body 402 of the garden tile 400. In alternative illustrative examples, the body 402 is elastic such that the garden tile 400 may exhibit a slight deformation due to a load (e.g., due to the weight of a person walking across the body 402) but will return to an initial form following such deformation.

The edges 410, 412 of the garden tile 400, corners on the garden tile 400, or a combination thereof may be shaped to reduce the possibility of chipping, other damage, or both. As such, the edges 410, 412, corners, or both may be chamfered, rounded, etc.

In the exemplary embodiment shown in FIG. 4, the garden tile 400 is generally rectangular in shape; however, other the body shapes may be implemented. The body shape determines the shape of rows for planting plants in a garden, as is described in greater detail below in reference to FIG. 7.

The dimensions of the garden tile 400 may be any dimensions. For example, in the exemplary rectangular embodiment of FIG. 1, the width of the body 402 of the garden tile 400 is thirty-and-one-half centimeters (“cm”) (approx. twelve inches) between the first edge 410 and the second edge 412; the length of the body 402 is 244 cm (approx. ninety-six inches); and the depth of the body 402 is 3.81 cm (approx. one-and-a-half inches). However, other dimensions may be used. For example, the width may be sixty-one cm (approx. twenty-four inches), and the length may be 183 cm (approx. seventy-two inches).

Moreover, the water channels 404 in the body 402 may be spaced apart at any desired distance. In the exemplary embodiment of FIG. 4, the water channels 404 are spaced apart by 2.54 cm (approx. one inch). However, any distance may be used depending on the desired water flow characteristics desired for the garden tile 400, because the length of the garden tile 400, the distance between the water channels 404, and the width of the water channels 404 define the maximum number of water channels 404 that can fit on the body 402 of the garden tile 400.

In exemplary implementations, the width of a water channel 404 may range from 0.159-2.54 cm (approx. one-sixteenth of an inch to one inch). For example, in the exemplary embodiment of FIG. 4, the width of the water channels 104 is 0.635 cm (approx. one-fourth of an inch). Furthermore, the width of the water channels 404 does not have to be uniform across all of the water channels 404, nor does the width of each individual water channel 404 need to be constant across that water channel 404.

In exemplary embodiments, except for the water channels 404, the top 406 of the garden tile 400 is generally flat as opposed to being sloped. Thus, a person can walk on the garden tile 400 without slipping. Moreover, although the channels 404 can be any desired width, in the illustrative implementation, the channel width is insufficient for a person walking across the garden tile 400 to slip down a slope of the water channel that is used to direct water toward plant roots.

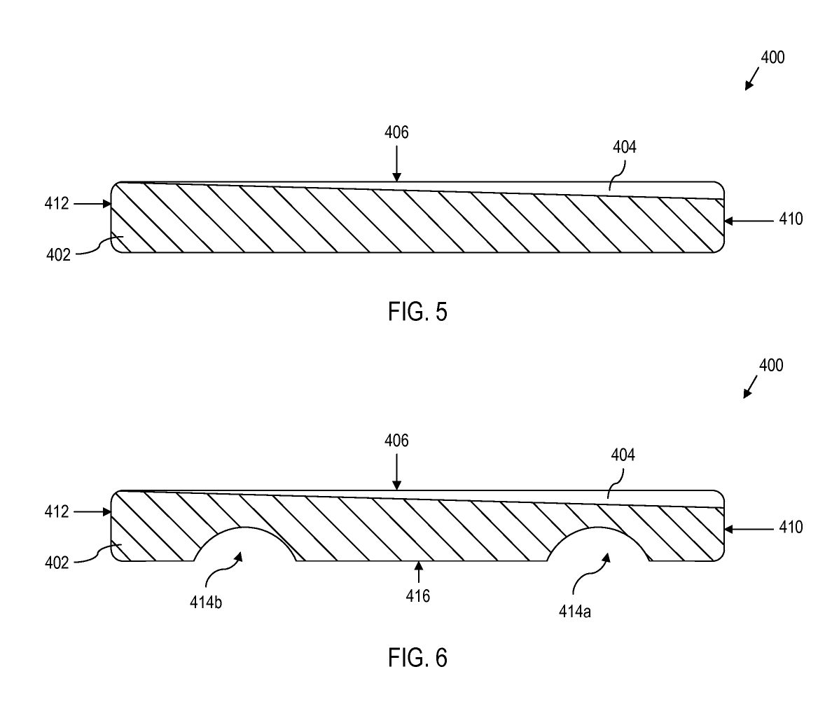

Referring now to FIG. 5, an exemplary cross section at a water channel 404 of the exemplary garden tile 400 of FIG. 4 is shown. As mentioned above, the top 406 of the body 402 includes water channels 404, which extend generally orthogonal to the elongated edges 410, 412 and starting generally at the second edge 412 of the top 406 of the body 402 and ending at the first edge 410.

The exemplary water channels 404 of FIG. 5 increase in depth linearly from the second elongated edge 412 on the top 406 of the body 402 toward the first elongated edge 410 such that the depth of the water channels 404 at the first edge 410 is 0.8 cm (approx. 5/16 inch). Thus, the slope of the water channel 404 is approximately 1-4 degrees from the top 406 of the body 402 of the garden tile.

The water channels 404 do not necessarily need to be linearly sloped. To the contrary, any manner sloping may be used (e.g., 1/x, x², etc.—where “x” is the distance from the starting point of the channel). However, the sloping of the depth of the water channels 404 should be monotonic (i.e., x₁≦x₂≦xₙ) to prevent water from pooling in the water channels 404, but monotonic sloping is not necessary. Further, each water channel 404 in the garden tile 400 does not need to be uniform with other water channels 404 within the garden tile 400.

Referring now to FIG. 6, an exemplary cross section at a water channel 404 of another exemplary garden tile 400 of FIG. 4 is shown. garden tile of FIG. 6 differs from the garden tile of FIG. 5 in that the garden tile 400 depicted in FIG. 6 includes two bottom channels 414a, 414b (collectively 114) in the bottom 416 of the body 404 of the garden tile 400. The bottom channels 414 are generally orthogonal to the water channels 404. The bottom channels 414 accommodate irrigation piping, accommodate irrigation tubing, reduce the amount of material used to create the garden tile 100, improve longitudinal characteristics, etc.

The exemplary garden tile 400 of FIG. 6 includes two bottom channels 414a, 414b; however, a different number of bottom channels 414 may be used (e.g., one channel, three channels, four channels, zero channels (as depicted in FIG. 5), etc.). Further, the bottom channels 414 may extend throughout the entire length of the garden tile 400 or may extend for only a portion of the garden tile 400. Moreover, as mentioned above, the bottom channels 414 are orthogonal to the water channels 404; however, other orientations of the bottom channels 414 are available. For example, the bottom channels may be parallel to the water channels 404, or the bottom channels 414 may not be linear at all and include some bends or curves.

As can be seen in the exemplary garden tiles of FIGS. 5-6, the water channels 414 do not cut entirely through the body 402 from top 406 to bottom 416. Therefore, when placed in a garden, no sunlight reaches the portion of the garden covered by the garden tile 400. Without sunlight, weeds will not grow beneath the garden tile 400. Thus, the garden tile 400 helps reduce time spent weeding by a gardener and herbicide usage. Also, less water will evaporate from the garden because less of the soil's surface area is exposed to the atmosphere.

The exemplary garden tiles discussed in reference to FIGS. 4-6 direct water that falls upon the tile through the water channels 404 only the first edge 410 of the garden tile 400. Thus, the garden tiles 400 of FIGS. 4-6 will water plants along one edge of the garden tile 400 and are suitable for placement along a border of a garden while still allowing a stable, flat surface for a person to walk upon.

Turning now to FIG. 7, an exemplary garden 700 made using the garden tiles 100 (i.e., center tile), 400 (i.e., border tile) of FIGS. 1-6 is shown. To create the garden 700, a gardener places a border tile 400a on the ground with the water channels of the border tile 400a sloping toward the garden 700. The gardener places a second border tile 400b opposite the first border tile 400a. The water channels of the second border tile 404b also slope toward the garden 700. The gardener places several center tiles 100 between the border tiles 400a-b (collectively 400). In the exemplary garden 700 of FIG. 7, the gardener has placed five center tiles 100a-e (collectively 100) between the two border tiles 400, thus creating six planting rows 702a-f (collectively 702). The planting rows 702 are where the gardener plants the plants 704a-f (collectively 704) (e.g., partially grown, fully grown, or seeds) for the garden 700.

An exemplary garden may also include more or less planting rows 702. For example, a gardener can use only two border tiles 400 to create one planting row 702. Also, a gardener may use the border tiles 400 and two center tiles 100 to create three planting rows 702. Further, the gardener may extend the length of the planting rows by using more than one border tile 400 or center tile 100 end-to-end.

Moreover, other shapes of garden tiles may be used. For example, circular tiles, triangular tiles, trapezoidal tiles, parallelogram tiles, etc. may be used. These different shapes allow a gardener to make different patterns of planting rows within the garden. However, the preferred embodiment for vegetable gardens uses the rectangular tiles and the linear planting rows.

Still further, all of the tiles in the garden 700 may be center tiles 100. However, such an arrangement may waste some of the water that collects on the outside sloping water channels. To prevent such a waste, the outside of the enclosed section of the garden may include another row of plants.

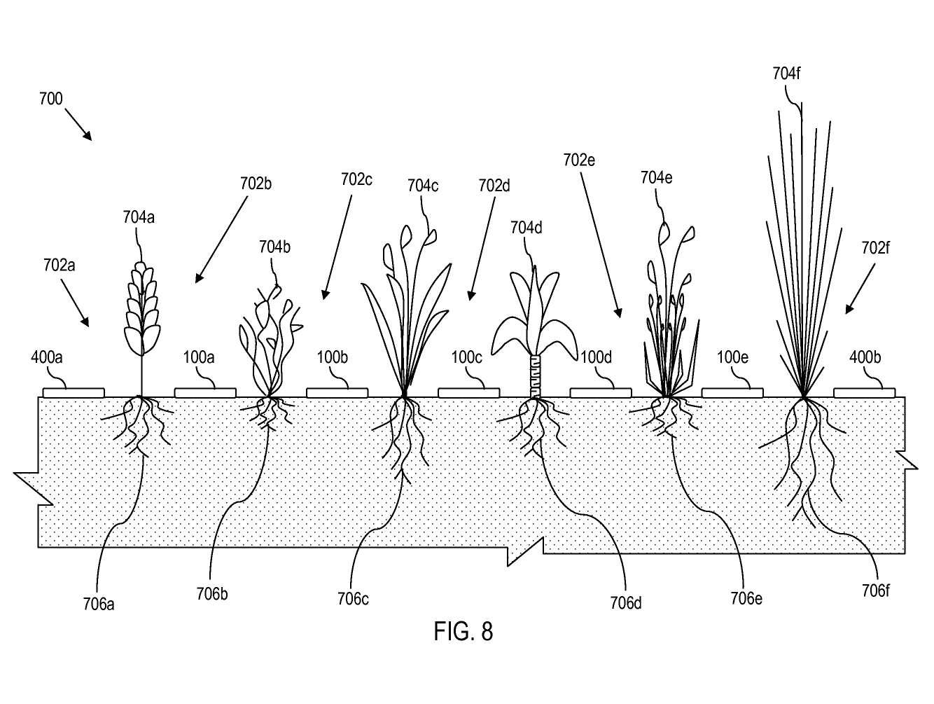

As can be seen in FIG. 8, the roots 706a-f (collectively 706) of the plants 704 are located near the edges of the tiles 100, 400. When rain water, irrigation water, or water from sprinklers falls on the garden 700, the tiles 100, 400 collect the water and the water channels direct the water to the roots 706 of the plants 704 at the edges of the tiles 100, 400. Thus, water is collected in the spaces that have no plants 704 (i.e., where the tiles are) and distributed to the roots 706 of the plants 704, which reduces the amount of wasted water.

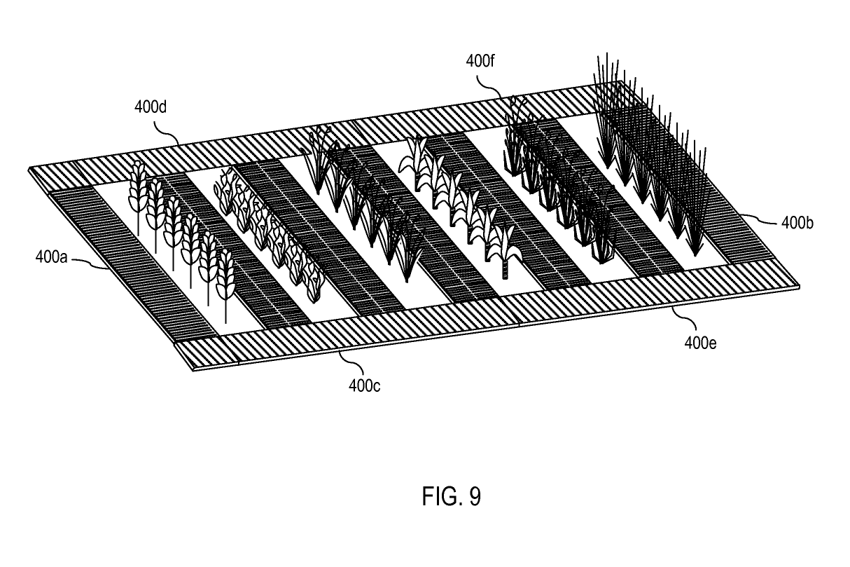

Referring now to FIG. 9, the gardener may place more border tiles 400 c-f to enclose the garden 700 in border tiles 400a-f. The water channels of these border tiles 400c-f also face inward toward the garden.

Because a gardener can walk on the garden tiles 100, 400, when the gardener is in the garden 700, there is a lower chance that the gardener's clothes will become soiled. Further, the flat top of the tiles 100, 400 provides a convenient surface for the gardener to walk upon.

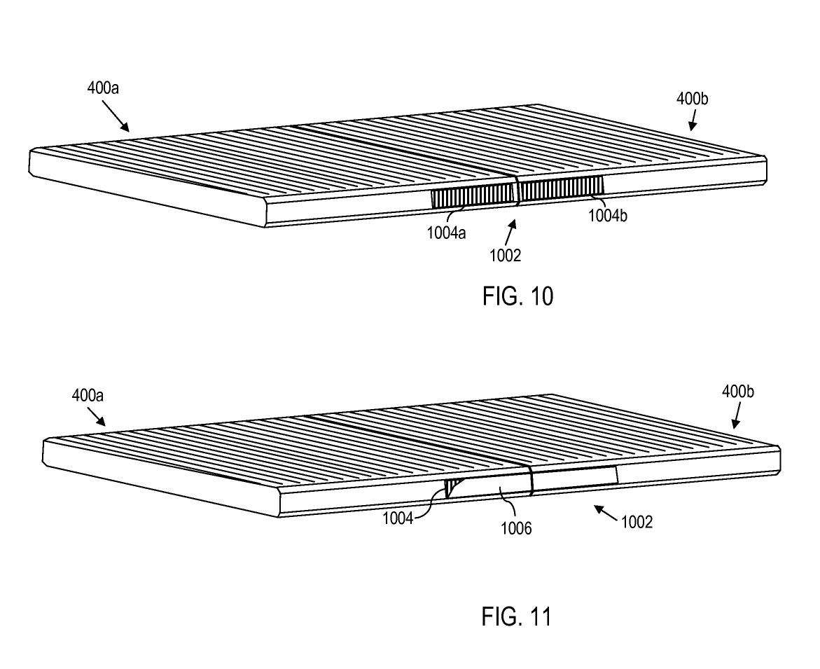

Referring now to FIGS. 10 and 11, two border tiles 400a, 400b are shown with couplers 1002. In the exemplary embodiment of FIGS. 10-11, the border tiles 400 include a hook portion 1004a, 1004b of a hook-and-loop coupler 1002. The loop portion 1006 of the hook-and-loop coupler 1002 couples to both of the hook portions 1004a, 1004b to couple the two border tiles 400a, 400b together. Other coupling mechanisms 1002 may also be used, such as, but not limited to, button, snaps, hooks, etc. Also, the couplers 1002 may be present on center tiles.

Further, the couplers 1002 may be positioned as to secure perpendicular tiles to form a corner, as opposed to tiles that form a straight line. Moreover, a garden tile may have more than one coupler portion to allow the garden tile to be coupled to more than one other garden tile.

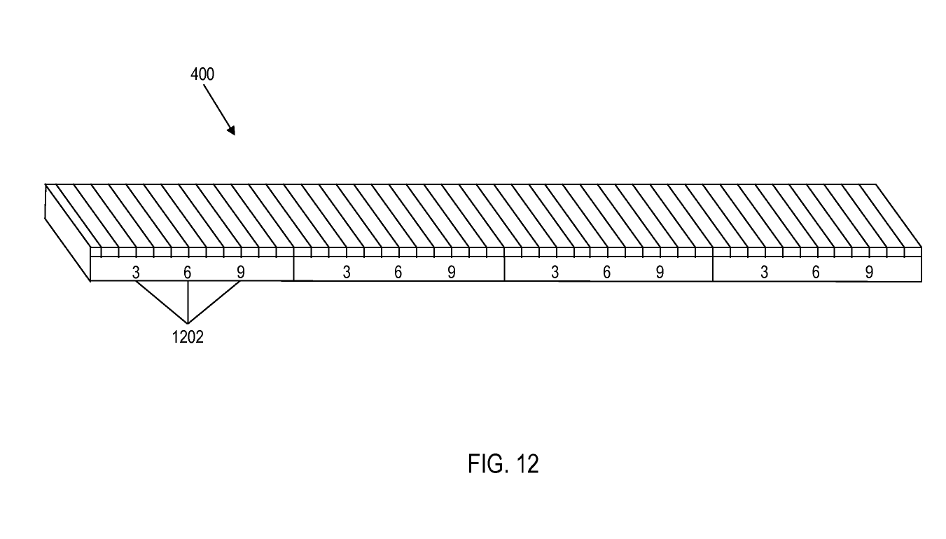

Referring now to FIG. 12, a border tile 400 with distance markings 1202 is shown. The distance markings indicate the length of the tile 400 and help in positioning center tiles properly within the garden. The exemplary border tile 400 of FIG. 12 is four feet long and includes distance markings every three inches. However, other distance marking lengths may be used, e.g., several inches, several centimeters, etc.

Further, the tiles 100, 400 may be colored (e.g., painted, stained, dyed before manufacture, etc.) to adjust heat retention properties of the tiles 100, 400 to control the temperature of the garden 700 soil. For example, if the tiles 100, 400 are colored black, the tiles 100, 400 will absorb heat from the sun, which will keep the soil at a higher temperature. As another example, white-colored tiles 100, 400 will reflect light and will have a cooler temperature than darker-colored tiles 100, 400. Thus, white-colored tiles will keep the soil cooler.

The garden tiles may be manufactured in any length and width, then cut to fit a gardener's purposes. The rigid tiles also allow for easy storage during non-growing seasons. Alternatively, the rot-resistant tiles may be left out in the garden during the non-growing season.

In an alternative embodiment, the tiles may be made from a flexible material that can be rolled and into compact rolls.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A garden tile comprising:
a body including a top and a first edge; and
water channels in the body, wherein the water channels are open to the top of the body and are sloped toward the first edge of the body;
wherein the body is constructed of a rigid material allowing a person to walk upon the body without substantially deforming the body and without substantially deforming the water channels.

2. The garden tile of claim 1, wherein:
the water channels slope from a general center of the body to the edge of the body such that the depth of the water channels is deeper at the first edge than the depth of the water channels at the general center of the body;
the body further includes a second edge, wherein the second edge is generally opposite of the first edge; and
water channels slope from the general center of the body to the second edge of the body such that the depth of the water channels is deeper at the second edge than the depth of the water channels at the general center of the body.

3. The garden tile of claim 2, wherein:
the body is generally rectangular in shape;
the water channels that extend to the first edge extend to the first edge without penetrating an entire way through the body of the tile; and
the water channels that extend to the second edge extend to the second edge without penetrating an entire way through the body of the tile.

4. The garden tile of claim 3, wherein the body includes:
a width of thirty-and-one-half centimeters (approx. twelve inches) between the first edge and the second edge; and
a depth of 2.54 cm (approx. 1 inch).

5. The garden tile of claim 4, wherein the water channels include a width of 0.635-0.3175 centimeters (approx. ¼ inch to ⅛ inch).

6. The garden tile of claim 4, wherein the water channels slope at an angle of 1-4 degrees.

7. The garden tile of claim 4, wherein the depth of the water channels at the first edge is 0.525 cm (approx. 3/16 inch).

8. The garden tile of claim 1, wherein:
the body further includes a second edge, wherein the second edge is generally opposite of the first edge; and
the water channels slope from the second edge of the body to the first edge of the body such that the depth of the water channels is deeper at the first edge than the depth of the water channel at the second edge.

9. The garden tile of claim 8, wherein:
the body is generally rectangular in shape; and
the water channels that extend to the first edge extend to the first edge without penetrating an entire way through the body of the tile.

10. The garden tile of claim 9, wherein the body includes:
a width of thirty-and-one-half centimeters (approx. twelve inches) between the first edge and the second edge; and
a depth of 2.54 cm (approx. 1 inch).

11. The garden tile of claim 10, wherein:
the water channels include a width of 0.635-0.3175 centimeters (approx. ¼ inch to ⅛ inch); and
the water channels slope at an angle of 1-4 degrees.

12. The garden tile of claim 10, wherein the depth of the water channel sat the first edge is 0.8 cm (approx. 5/16 inch).

13. The garden tile of claim 1, wherein the top of the body, except where the water channels open to the top, provides a flat surface generally parallel to a bottom of the body.

14. The garden tile of claim 1, wherein the body further includes:
a bottom, and
a bottom channel that runs along the bottom of the body and is substantially orthogonal to the water channels.

15. The garden tile of claim 1 further including a coupler that couples the body to another garden tile.

16. The garden tile of claim 1, wherein the body further includes distance measurement markings.

17. A method of gardening, the method comprising:
placing, on the ground, a first garden tile including water channels sloped toward a first edge of the first garden tile;
placing, on the ground generally parallel to the first garden tile, a second garden tile including water channels sloped toward a first edge of the second garden tile, such that the first edge of the first garden tile is facing the first edge of the second garden tile, and such that the first garden tile is spaced apart from the second garden tile to form a planting row; and
planting plants in the planting row.

18. The method of claim 17, wherein:
the first garden tile further includes water channels sloped toward a second edge; and
the method further comprises:
placing, on the ground generally parallel to the first garden tile, a third garden tile including water channels sloped toward a first edge of the third garden tile, such that the second edge of the first garden tile is facing the first edge of the third garden tile, and such that the first garden tile is spaced apart from the third garden tile to form a second planting row; and
planting plants in the second planting row.

19. The method of claim 18 further comprising:
placing, on the ground generally orthogonal to the first garden tile, a first border tile including water channels sloped toward a first edge of the first border tile, wherein the first edge of the first border tile faces the planting row.

20. The method of claim 19 further comprising:
placing, on the ground generally orthogonal to the first garden tile, a second border tile including water channels sloped toward a first edge of the second border tile; and
coupling the first border tile to the second border tile.
